(19) United States
(12) Patent Application Publication
(10) Pub. No.: US 2025/0109958 A1
(43) Pub. Date: Apr. 3, 2025

(54) SYSTEM AND METHOD FOR LOCAL SHOPPING

(71) Applicant: Arthur E Haas Jr, Clarksville, TN (US)

(72) Inventor: Arthur E Haas Jr, Clarksville, TN (US)

(21) Appl. No.: 18/895,199

(22) Filed: Sep. 24, 2024

Related U.S. Application Data
(60) Provisional application No. 63/587,531, filed on Oct. 3, 2023.

(51) Int. Cl. G01C 21/36; G06Q 30/0601

(52) U.S. Cl. CPC G01C 21/3614; G01C 21/3682; G01C 21/3697; G06Q 30/0633; G06Q 30/0639; G06Q 30/0643

(57) ABSTRACT

A system and method for assisted local shopping that allows a user to check availability of items in local stores and get best deals. The method includes steps of receiving geographical location of a user and a distance value from the geographical location to determine a geographical area of interest to the user. Stores within this geographical area can be enquired by the system for the availability of items in a cart created by the user. Stores having said items can be presented to the user. The system can also determine cart value for each selected store and display the cart value along with the respective store on a geographical dynamic map to the user.

### CROSS-REFERENCE TO RELATED APPLICATIONS

This application claims priority from a U.S. Provisional Patent Appl. No. 63/587,531, filed on Oct. 3, 2023, which is incorporated herein by reference in its entirety.

### FIELD OF INVENTION

The present invention relates to a system and method for assisting in local shopping, and more particularly, the present invention relates to a system and method for listing of products by local shops.

### BACKGROUND

Shopping for groceries, household items, tools, and the like is necessary for most people. Some people enjoy shopping for these articles, but it can get frustrating for many. In particular, when a store does not have all the desired items, a person has to search for the items in different stores, which gets frustrating, laborious, and time-consuming. Besides availability, the cost of items also plays an important role in shopping. People intend to buy items from stores selling the items cheaper. For example, some stores may have better deals on certain items than other stores. However, finding the best deals in stores can be very laborious and time-consuming for a customer. Often the customer buys items at premium prices while the same items are available from a different store at discounted rates.

Thus, a need is appreciated for a system that can assist individuals in local shopping.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for assisted local shopping.

Another object of the present invention is that businesses can advertise deals and offers.

Still, another object of the present invention is that the customers can get the best deal without searching different stores.

Yet another object of the present invention is that the customer can easily locate a store having the desired item.

A further object of the present invention is that the customer does not have to look for items in different stores.

In one aspect, disclosed are a system for assisting in local shopping, the system comprises a processor and a memory, the system configured to implement a method comprising receiving, through an interface by the system, a geographical location and a distance value from the geographical location; receiving a list of items, through the interface by the system, forming a digital cart; determining, by the system, a geographical area based on the geographical location and the distance value using geographical positioning system and geographical information technologies; enquiring, by the system, digital inventory of predefined stores in the geographical area to determine selected stores having all the items in the digital cart; determining, by the system, a cart value for each of the selected stores; and implementing a dynamic map window through the interface on a user device, wherein the dynamic map window comprises a geographical map of the geographical area, icons pointing to geographical locations of the respective selected stores on the geographical map, and cart values of the selected stores presented adjacent to the respective icons.

In one aspect, each icon is actionable and configured to receive a selection from a user. The method further comprises receiving, through the interface, by the system, the selection of a store from the selected stores; and processing, by the system, the digital cart from the store for ordering. The geographical map, the icons, and the cart value are presented as layers in the dynamic map window, wherein each layer is configured to be switched between visible and hidden. The icons incorporate logos of the respective selected stores.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram showing the environment of the system, according to an exemplary embodiment of the present invention.

FIG. 2 is a block diagram showing the architecture of the system, according to an exemplary embodiment of the present invention.

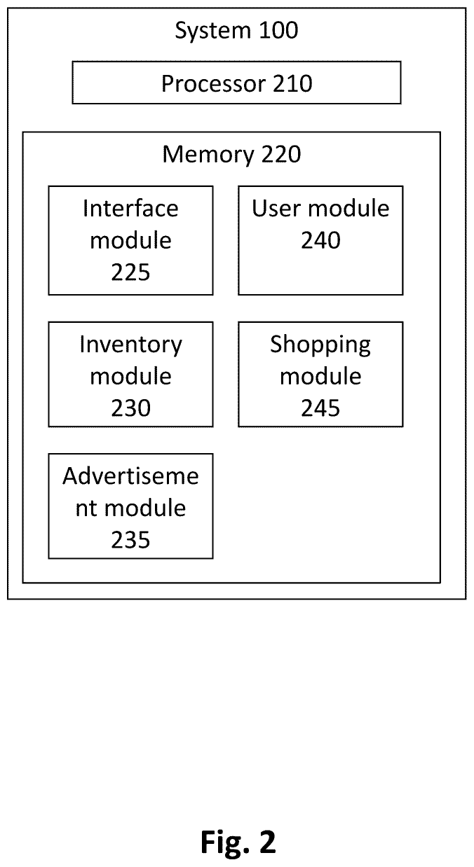

FIG. 3 shows a home screen of the interface, according to an exemplary embodiment of the present invention.

FIG. 4 shows a cart screen of the interface, according to an exemplary embodiment of the present invention.

FIG. 5 shows a price screen of the interface, according to an exemplary embodiment of the present invention.

FIG. 6 shows a notification screen of the interface, according to an exemplary embodiment of the present invention.

FIG. 7 is a flowchart showing the method, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the allowed claims of any resulting patent will best define the scope of the invention.

The present invention pertains to a system and method for local shopping. The system and method allow stores, such as local shops, marts, supermarkets, and the like to list their products with their availability and price. The system and method allow businesses to advertise promotional offers and deals to customers. The system and method allow customers to check products in nearby stores through their user devices. The customers can compare prices of any product using their user device without visiting the shops. The customers, while local shopping, can easily find out the best deals on products they are looking for. At the same time, the customers can know the availability of a product at a particular store using their user device. The customer may also get an option to reserve the products through their user devices so that they may be available when the customer reaches the store. This may be advantageous when the customers want to physically inspect the product before buying. Also, the customers can place the order from their user devices and can later go to the respective store to pick up the same. The disclosed system can make it possible for a user to at least know the best available deals in a certain area.

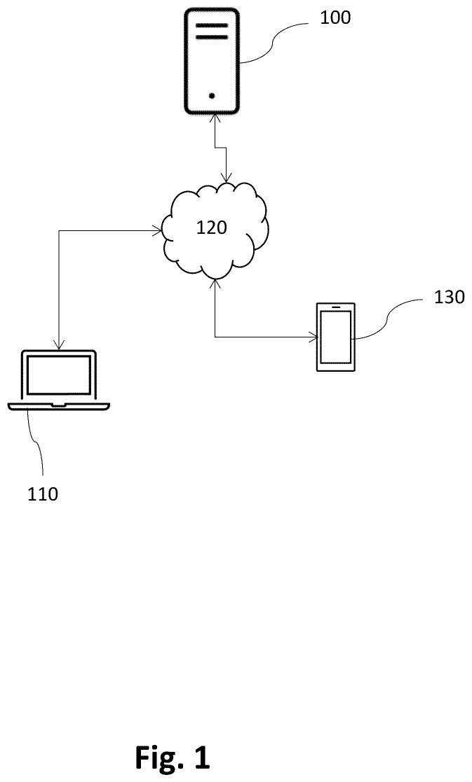

Referring to FIG. 1, a block diagram showing an environment of the disclosed system 100. System 100 can connect to a seller device 110 and a customer device 130 through a network 120. The seller and the customer are also referred to herein as a user. The term “user” as used herein, and throughout this disclosure, refers to an individual engaging a user device to interact with the system. Similarly, the term user device encompasses seller devices and customer devices. The user device can be any computing device that includes a processor for processing instructions stored in memory. The user device can also include an input module for receiving input from the user. Such input can be in the form of a touch display, mouse, stylus, keyboard, touchpad, and the like. The user device may also include a display for presenting information to the user, for example, an LCD screen. The user device may also include a network circuitry for connecting to the network 120. Examples of the user device include a smartphone, a desktop computer, a laptop, a workstation, and the like.

The network can be a communication network known in the art which can be a wired network, a wireless network, or may include a combination of wired and wireless networks. Examples of communication networks may be a local area network (LAN), a wide area network (WAN), a wireless WAN, a wireless LAN (WLAN), a metropolitan area network (MAN), a wireless MAN network, a cellular data network, a cellular voice network, the Internet, etc. While, for the purpose of illustration herein, FIG. 1 shows a single network connecting multiple user devices, it should be obvious to those reading this disclosure that different user devices can connect with the system through various networks, and the same user device can connect with the system through more than two networks. For example, a user device can connect to the system through a LAN and the Internet.

System 100 includes a processor 210 and a memory 220 operably coupled to the processor. The processor can be any logic circuitry that responds to, and processes instructions fetched from the memory. The memory may include one or more memory chips capable of storing data and allowing any storage location to be directly accessed by the processor. The memory can include modules according to the present invention for execution by the processor to perform one or more steps of the disclosed methodology.

The memory may include an interface module 225 which upon execution by the processor can provide an interface on a user device for interacting with the system; an inventory module 230 which upon execution by the processor can allow a seller to list their products with cost and discounts; an advertisement module 235 which upon execution by the processor can allow a seller to advertise; a user module 240 which upon execution by the processor can allow an individual to register with the system; and a shopping module 245 which upon execution by the processor can allow a customer to find products in nearby stores with their prices.

The term module as used herein and throughout this disclosure refers to software, a program code, a set of rules or instructions, and the like in one or more computer-readable languages including graphics, which upon execution by the processor performs one or more steps of the disclosed methodology. Also, operations may be described as a sequential process, some of the operations may be performed in parallel, concurrently, and/or in a distributed environment, and with program code stored locally or remotely for access by single or multi-processor machines. In addition, in some implementations, the order of operations may be rearranged without departing from the spirit of the disclosed subject matter.

The system can be implemented in the form of servers, which include cloud servers. The servers can be placed in one location or geographically dispersed. Also, one or more steps of the disclosed methodology can be performed on one or more user devices without departing from the spirit of the disclosed subject matter.

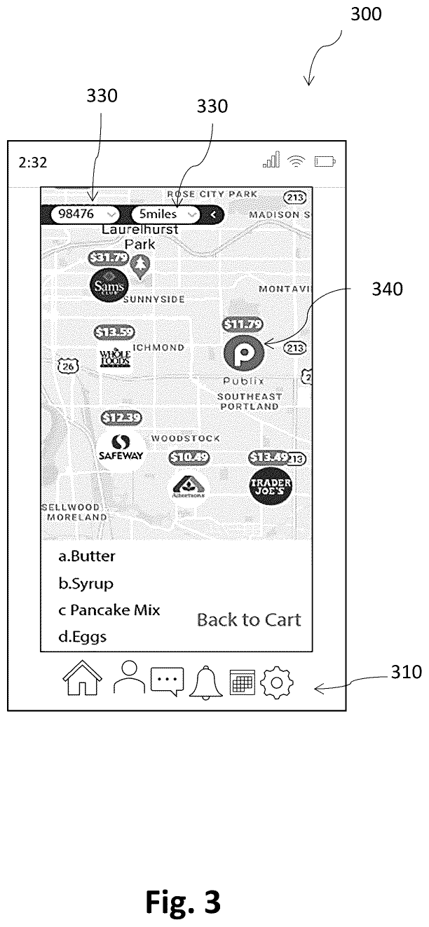

The interface provided by the interface module allows a user to interact with the disclosed system through a user device. The interface may include a series of screens, as shown in FIGS. 3-6, which in continuation can provide information as well as receive information from the user and execute one or more steps of the disclosed methodology. The interface can be dynamic and allows switching between sections, screens, pages, and the like quickly and easily. The interface can be provided as an application software that can be installed on the user device. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the World Wide Web. The application software can also be provided for the desktop environment, such as Windows™, Linux, and macOS. The user interface may permit interaction with a user through the user device, wherein information can be presented within the user interface by system 100 and information can be received by system 100 from the user.

The user module may allow an individual willing to use the disclosed system to register. The user module can receive basic information about the individual, such as name, Home Address, and Work Address (if pertinent) with Zip Codes, Phone Number, Email Address, and the like. Different information can be obtained from a seller and a customer, and accordingly, different registration screens can be provided on the seller device and the customer device. The system can determine the geographical coordinates of a store or a consumer address through a physical address. Also, the system can obtain the same through a GPS circuitry built into the user device. The user module can generate a profile for the user and store the same in a suitable database. The present invention can use any suitable database known in the art for storing customers' data without departing from the scope of the present invention. Also, the profile created by the user module can be later modified by the user. For example, FIG. 3 shows a home screen 300 including an avatar icon in a navigation bar 310. Clicking the avatar icon opens another screen that may present the profile as a form. The user has the option to edit entries or add more information, and the user module can update the respective profile in the database.

The user module can generate login details to access the disclosed system securely. The login details may include at least a username and a password. The password can be an alphanumeric code, or biometric like a fingerprint, token, and the like. The user may have multiple login options, such as using an alphanumeric code or a fingerprint. Also, the use of multiple-factor authentication is within the scope of the present invention. The user can be provided with a login screen on the user device for accessing the disclosed system.

FIG. 3 shows a home screen 300 of the interface that can be presented on a customer device though the interface module. The home screen is presented on the customer device when the customer login into the system. The home screen allows a user to search for items along with their prices in nearby stores. As shown in the drawing, a drop-down bar 320 is shown in top left of the screen that allows the user to enter an area code. On the top right side is another drop down bar 330 that allows the user to enter distance, the distance can be the distance from current location of the customer device or registered address of the customer. Thus, the customer can be provided with two options to search the nearby stores. The area code can limit the stores within the area or nearby the area code. The distance option can indicate how far the customer is willing to travel to purchase wanted items.

The screen 300 shown in FIG. 3 further includes a map window that can present a dynamic multilayer map. First, the window includes geographical map of the area and distance selected by the user. The geographical map can dynamically change with change in distance received by the system from the user. Another layer on the geographical map shows the geographical coordinates of stores in the area. The stores are shown with the help of icons pointing towards the geographical coordinate of respective stores. Another layer is implemented that includes the cart value for the respective stores. This cart value is shown adjacent to the icon of the respective stores. The screen further shows cart at the bottom of the window. This cart can be optionally made visible or can be made hidden by the user.

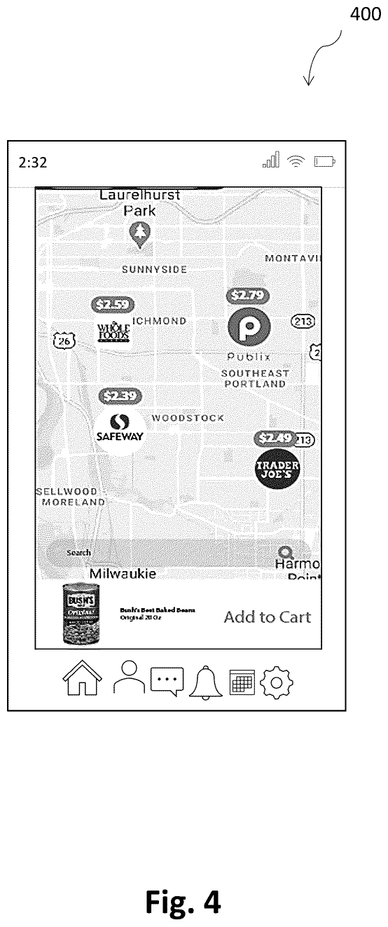

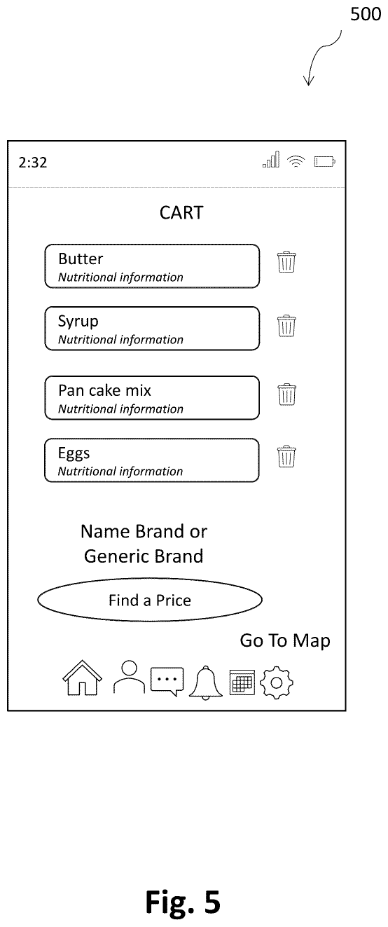

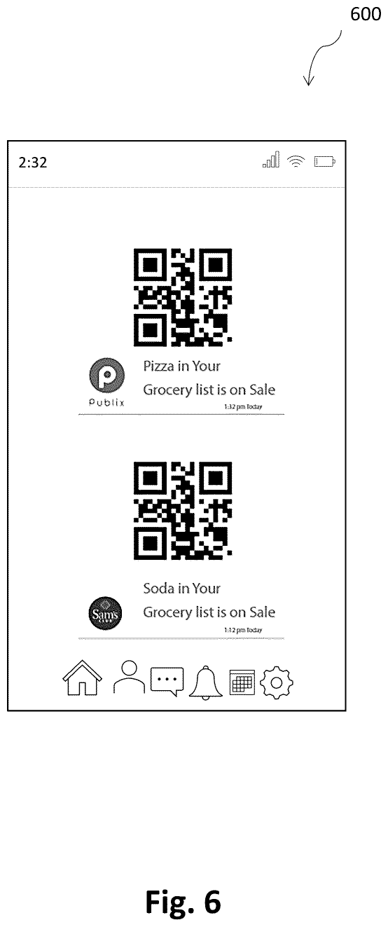

To add items to the cart, a screen 400 shown in FIG. 4 can be presented on the user device. The screen 400 allows the user to add items they would like to purchase to a shopping cart. For example, the user can add butter, syrup, pancake mix, eggs (or paint brush, painter tape, drop cloth). The user can enter as many items as possible, however, a limit to number of items that can be added can be limited. The user can also select whether they wish to purchase ONLY name brand items versus a store brand or other brands on the shelf. The user can also delete can item from the cart or modify their quantities. Based on the customer's current location, zip code, and how far they are willing to travel, the system can calculate the total cost for the items in the cart at predefined stores within the shopping radius. The system can then present the information as a layer on a map of the locality. The information includes the name of the store and the total cart value. The information can be presented in multiple transparent layer over the map. The user can have the option to choose which information is visible. The map may show the store logo as icons or labels, and adjacent to the icon can be displayed total cost. On the map, the current location of the customer and that of the stores can be made visible. This allows the user to know the distance of the stores from the customer's location. A single screen, shown in FIG. 3, shows the dynamic multilayer map, cart, zip code bar, and the distance bar. The user can change the distance anytime and the information on the dynamic map can be presented. The user can click a store icon on the map, which creates a pop-up window, in which more information can be displayed. The more information includes details of the store and discounts offered, item-wise break up of cart, and the like. FIG. 5 shows a cart screen that allows a user to add and remove items from the cart. FIG. 6 shows a notification screen which can display advertisements.

As shown in FIG. 4, the user can add items and with each addition, the dynamic map can change showing the stores that include all the items with the new cart value. The user can click the icon of respective store and view item list with cost. Stores which may not include all the items can also be displayed in the map window. Such store icons can be shadowed i.e., certain amount of transparency can be added to these icons to distinguish them. No cart value may be displayed with these icons; however, the user may click such icons and view the items with their cost that are available at the store.

In certain implementations, the system can display a running total of how much money is saved. Also, the user can be automatically signed with any loyalty program in nearby stores by the system using information from the profile of the user. This ensures maximum savings for the customer while avoiding the hardship of registering and maintaining the registrations with multiple stories. The system allows a customer at home or at work heading home to receive information to help cut down on grocery shopping and home improvement expenses. It will also reduce the time one spends shopping by finding the best prices on the items in need. Grocery shoppers, contractors (plumbers/electricians/home construction professionals), and DIYs, all can benefit with the disclosed system. Also, there may be some markets/stores close to one's work/jobsite that are not close to the home, and the system can do a price check at these locations for even greater convenience and savings.

As supermarkets and most other retail venues increasingly abandon physical flyer mailings for their weekly sales promotions, the task of finding the most cost-effective items for grocery shopping and other items has grown more complex. To secure access to the best deals, individuals are often required to download each store's dedicated app, complete registration procedures, and then search for their desired products. The disclosed system streamlines this entire process within a single comprehensive app. It not only consolidates all these tasks for the customer but also takes care of the registration for store discounts where available. Once registered, customers will start receiving emails from their chosen local supermarkets and big box home improvement stores that are likely to include QR codes or UPCs, further simplifying the process.

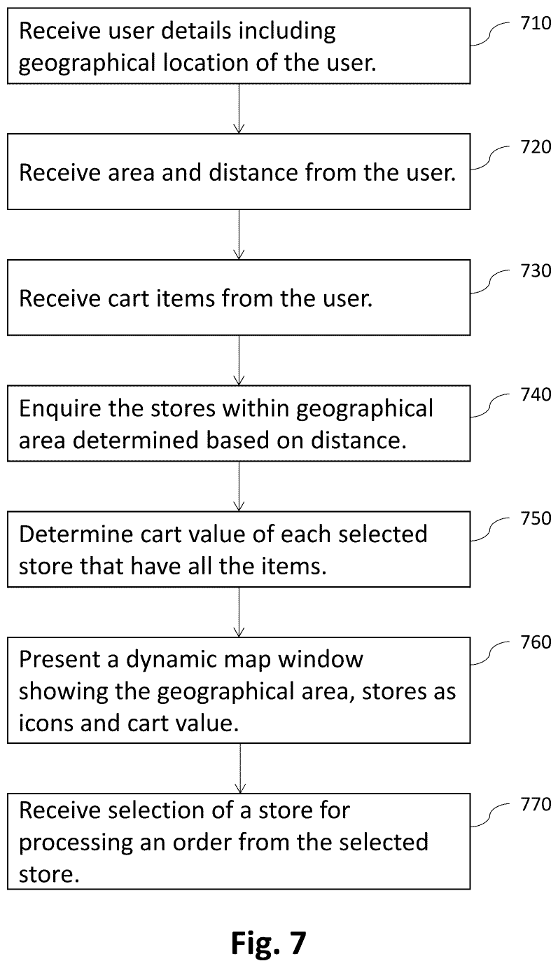

Referring to FIG. 7 which is a flowchart illustrating the method implemented by the disclosed system. First, the system may receive name and address of a consumer, at step 710. Particularly, the system can determine geographical coordinates of the user. The system can then receive area and distance from the user, at step 720. The system can then receive cart items from the user through the cart screen implemented on the user device, at step 730. The system can then enquire the inventory of the stores lying within the geographical area determined based on location and distance provided by the user, at step 740. System can determine which stores have all the items in the cart. The system can also receive cost of each item from selected stores, the selected stores are the stored within the selected geographical area that has all the items in the cart. The system can then determine cart value for each selected store, at step 750. The system can then present a dynamic map window which shows a map of the selected geographical area, selected stores as icons, and the cart value, at step 760. The user can optionally click any icon of the store to order the cart items from the store, at step 770.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system for assisting in local shopping, the system comprises a processor and a memory, the system configured to implement a method comprising:
receiving, through an interface by the system, a geographical location and a distance value from the geographical location;
receiving a list of items, through the interface by the system, forming a digital cart;
determining, by the system, a geographical area based on the geographical location and the distance value using geographical positioning system and geographical information technologies;
enquiring, by the system, digital inventory of predefined stores in the geographical area to determine selected stores having all the items in the digital cart;
determining, by the system, a cart value for each of the selected stores; and
implementing a dynamic map window through the interface on a user device, wherein the dynamic map window comprises a geographical map of the geographical area, icons pointing to geographical locations of the respective selected stores on the geographical map, and cart values of the selected stores presented adjacent to the respective icons.

2. The system of claim 1, wherein each icon is actionable and configured to receive a selection from a user.

3. The system of claim 2, wherein the method further comprises:
receiving, through the interface, by the system, the selection of a store from the selected stores; and
processing, by the system, the digital cart from the store for ordering.

4. The system of claim 1, wherein the geographical map, the icons, and the cart value are presented as layers in the dynamic map window, wherein each layer is configured to be switched between visible and hidden.

5. The system of claim 1, wherein the icons incorporate logos of the respective selected stores.

6. A method for assisted local shopping, the method implemented within a system comprising a processor and a memory, the method comprising:
receiving, through an interface by the system, a geographical location and a distance value from the geographical location;
receiving a list of items, through the interface by the system, forming a digital cart;
determining, by the system, a geographical area based on the geographical location and the distance value using geographical positioning system and geographical information technologies;
enquiring, by the system, digital inventory of predefined stores in the geographical area to determine selected stores having all the items in the digital cart;
determining, by the system, a cart value for each of the selected stores; and
implementing a dynamic map window through the interface on a user device, wherein the dynamic map window comprises a geographical map of the geographical area, icons pointing to geographical locations of the respective selected stores on the geographical map, and cart values of the selected stores presented adjacent to the respective icons.

7. The method of claim 6, wherein each icon is actionable and configured to receive a selection from a user.

8. The method of claim 7, wherein the method further comprises:
receiving, through the interface, by the system, the selection of a store from the selected stores; and
processing, by the system, the digital cart from the store for ordering.

9. The method of claim 6, wherein the geographical map, the icons, and the cart value are presented as layers in the dynamic map window, wherein each layer is configured to be switched between visible and hidden.
The method of claim 6, wherein the icons incorporate logos of the respective selected stores.
